(19) United States
(12) Patent Application Publication
(10) Pub. No.: US 2026/0206041 A1
(43) Pub. Date: Jul. 16, 2026

(54) SIDELINK TRANSMISSION METHOD AND TERMINAL DEVICE

(71) Applicant: GUANGDONG OPPO MOBILE TELECOMMUNICATIONS CORP., LTD., Dongguan (CN)

(72) Inventors: Teng MA, Dongguan (CN); Zhenshan ZHAO, Dongguan (CN); Shichang ZHANG, Dongguan (CN)

(21) Appl. No.: 19/550,860

(22) Filed: Feb. 26, 2026

Related U.S. Application Data
(63) Continuation of application No. PCT/CN2023/139216, filed on Dec. 15, 2023.

(51) Int. Cl. H04W 72/25; H04W 52/06

(52) U.S. Cl. CPC H04W 72/25; H04W 52/06

(57) ABSTRACT

Provided is a sidelink transmission method and a device relating to the technical field of communications. The method is performed by a terminal device and includes: repeatedly transmitting first sidelink data in N contiguous slots, wherein a transmit power in each of the N contiguous slots is less than a first transmit power, the first transmit power being less than or equal to a maximum transmit power allowed for the first terminal device, and N being a positive integer greater than 1.

### CROSS REFERENCE TO RELATED APPLICATION

This application is a continuation of International Application No. PCT/CN2023/139216, filed Dec. 15, 2023, the entire disclosure of which is incorporated herein by reference.

### TECHNICAL FIELD

Embodiments of the present disclosure relate to the technical field of communications, and in particular, relate to a sidelink transmission method and a terminal device therefor.

### RELATED ART

In a sidelink communication system, sidelink data is typically transmitted in units of slots. During transmission of the sidelink data, how to ensure coverage performance while simultaneously reducing the power consumption of a terminal device is a problem to be solved.

### SUMMARY

Embodiments of the present disclosure provide a sidelink transmission method and a terminal device therefor. The following describes the various aspects of the present disclosure.

According to some embodiments of the present disclosure, a sidelink transmission method is provided. The method includes: repeatedly transmitting first sidelink data in N contiguous slots, wherein a transmit power in each of the N contiguous slots is less than a first transmit power, the first transmit power being less than or equal to a maximum transmit power allowed for the first terminal device, and N being a positive integer greater than 1.

According to some embodiments of the present disclosure, a sidelink transmission method is provided. The method includes: receiving first sidelink data in S slots of N contiguous slots, the N contiguous slots being used to repeatedly transmit the first sidelink data, wherein N is a positive integer greater than 1, and S is a positive integer less than or equal to N.

According to some embodiments of the present disclosure, a terminal device is provided. The terminal device includes a transceiver, a memory, and a processor, wherein the memory stores one or more computer programs, and the processor is configured to perform: repeatedly transmitting first sidelink data in N contiguous slots, wherein a transmit power in each of the N contiguous slots is less than a first transmit power, the first transmit power being less than or equal to a maximum transmit power allowed for the first terminal device, and N being a positive integer greater than 1.

### BRIEF DESCRIPTION OF DRAWINGS

FIG. 1 is a schematic structural diagram of architecture of a wireless communication system according to some embodiments of the present disclosure;

FIG. 2 is a schematic diagram of a scenario for in-coverage sidelink communication according to some embodiments of the present disclosure;

FIG. 3 is a schematic diagram of a scenario for partial-coverage sidelink communication according to some embodiments of the present disclosure;

FIG. 4 is a schematic diagram of a scenario for out-of-coverage sidelink communication according to some embodiments of the present disclosure;

FIG. 5 is a schematic diagram of a scenario for sidelink communication based on a central control node according to some embodiments of the present disclosure;

FIG. 6 is a schematic diagram of a sidelink communication scheme based on broadcast according to some embodiments of the present disclosure;

FIG. 7 is a schematic diagram of a sidelink communication scheme based on unicast according to some embodiments of the present disclosure;

FIG. 8 is a schematic diagram of a sidelink communication scheme based on groupcast according to some embodiments of the present disclosure;

FIG. 9A is a schematic diagram of a slot structure adopted by a sidelink communication system according to some embodiments of the present disclosure;

FIG. 9B is another schematic diagram of a slot structure adopted by a sidelink communication system according to some embodiments of the present disclosure;

FIG. 10 is a schematic diagram of a time-domain relationship between a physical sidelink shared channel (PSSCH) demodulation reference signal (DMRS) and sidelink control information (SCI) according to some embodiments of the present disclosure;

FIG. 11 is a schematic diagram comparing the slot structures corresponding to multiple transmissions according to some embodiments of the present disclosure;

FIG. 12 is a schematic diagram of a physical sidelink control channel (PSCCH) DMRS mapping scheme according to some embodiments of the present disclosure;

FIG. 13 is a schematic diagram of a PSCCH DMRS mapping scheme in a time-domain according to some embodiments of the present disclosure;

FIG. 14 is a schematic diagram of a PSCCH DMRS mapping scheme in a frequency-domain according to some embodiments of the present disclosure;

FIG. 15 is a schematic diagram of a channel state information reference signal (CSI-RS) mapping scheme in a sidelink according to some embodiments of the present disclosure;

FIG. 16 is a schematic diagram of a listen-before-talk (LBT) process according to some embodiments of the present disclosure;

FIG. 17 is a schematic diagram of a transmit power of a PSSCH/PSCCH according to some embodiments of the present disclosure;

FIG. 18 is a schematic flowchart of a sidelink transmission method according to some embodiments of the present disclosure;

FIG. 19 is a schematic diagram of a power allocation scheme in a sidelink retransmission process according to some embodiments of the present disclosure;

FIG. 20 is another schematic diagram of a power allocation scheme in a sidelink retransmission process according to some embodiments of the present disclosure;

FIG. 21 is another schematic diagram of a power allocation scheme in a sidelink retransmission process according to some embodiments of the present disclosure;

FIG. 22 is another schematic flowchart of a sidelink transmission method according to some embodiments of the present disclosure;

FIG. 23 is a schematic structural diagram of a terminal device according to some embodiments of the present disclosure;

FIG. 24 is another schematic structural diagram of a terminal device according to some embodiments of the present disclosure; and

FIG. 25 is a schematic structural diagram of an apparatus according to some embodiments of the present disclosure.

### DETAILED DESCRIPTION

### Architecture of Communication System

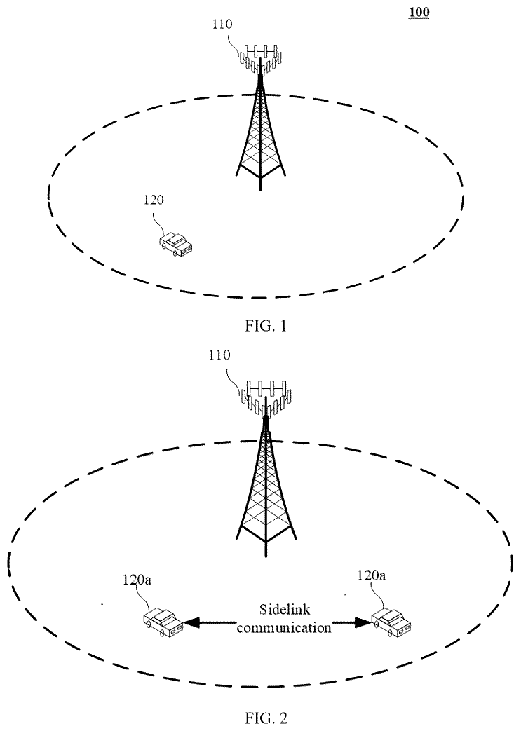

FIG. 1 is a schematic structural diagram of architecture of a wireless communication system 100 according to the embodiments of the present disclosure. The wireless communication system 100 may include a network device 110 and a terminal device 120. The network device 110 may be a device that communicates with the terminal device 120. The network device 110 may provide communication coverage for a designated geographic area and may communicate with the terminal device 120 within the coverage area.

FIG. 1 exemplarily illustrates one network device and one terminal device. Optionally, the wireless communication system 100 may include one or more network devices 110 and/or one or more terminal devices 120. For one network device 110, the one or more terminal devices 120 may all be within the network coverage (in-coverage) of the network device 110, or all outside of the network coverage (out-of-coverage) of the network device 110, or some of the terminal devices 120 may be within the network coverage of the network device 110 while some are out of the network coverage (partial-coverage) of the network device 110, which is not limited in the present disclosure.

Optionally, the wireless communication system 100 may include a network controller, a mobility management entity, and other similar network entities, which is not limited in the present disclosure.

It should be understood that the technical solutions of the present disclosure are applicable to various communication systems, such as: a 5^{th} generation (5G) system or new radio (NR), a long-term evolution (LTE) system, a frequency division duplex (FDD) LTE system, a time division duplex (TDD) LTE system, and the like. The technical solutions of the present disclosure are also applicable to future communication systems, such as a sixth generation communication system, a satellite communication system, or the like.

The terminal device in the embodiments of the present disclosure may be referred to as a user equipment (UE), an access terminal, a subscriber unit, a subscriber station, a mobile station (MS), a mobile terminal (MT), a remote station, a remote terminal, a mobile device, a user terminal, a terminal, a wireless communication device, a user agent, or a user device. The terminal device in the embodiments of the present disclosure may be a device that provides voice and/or data connectivity to a user, and may be used to connect people, objects, and machines, such as a handheld device, an in-vehicle device, and the like with a wireless connection function. The terminal device in the embodiments of the present disclosure may be a mobile phone, a pad, a tablet computer, a laptop computer, a palmtop computer, a personal digital assistant (PDA), a mobile internet device, a wearable device, a vehicle, a wireless terminal in industrial control, a wireless terminal in self-driving, a wireless terminal in remote medical surgery, a wireless terminal in a smart grid, a wireless terminal in transportation safety, a wireless terminal in a smart city, a wireless terminal in a smart home, and the like. For example, the terminal device may function as a scheduling entity, providing a sidelink signal between terminal devices in scenarios such as vehicle-to-everything (V2X) or device-to-device (D2D) communications, and the like. For example, a cellular phone and the vehicle communicate with each other based on the sidelink signal. The cellular phone may communicate with a smart home device without relaying communication signals via a base station. Optionally, the terminal device may function as a base station.

The network device in the embodiments of the present disclosure may be a device communicating with the terminal device. The network device may be referred to as an access network device or a radio access network (RAN) device, and may also be referred to as a base station. The network device in the embodiments of the present disclosure may be a radio access network node (or device) connecting the terminal device to the wireless network. The base station may broadly encompass various names listed below or may be interchangeable with the following terms, such as a NodeB, an evolved NodeB (eNB), a next generation NodeB (gNB), a relay station, an access point, a transmission reception point (TRP), a transmission point (TP), a master NodeB (MeNB), a secondary NodeB (SeNB), a multi-standard radio (MSR), a family station, a network controller, an access node, a radio node, an access point (AP), a transmission node, a transceiver node, a base band unit (BBU), a remote radio unit (RRU), an active antenna unit (AAU), a remote radio head (RRH), a central unit (CU), a distributed unit (DU), a positioning node, and the like. The base station may be referred to as a communication module, a modem, or a chip designed for integration within the aforementioned equipment or devices. The base station may also be a mobile switching center, a device implementing the functions of a base station in D2D, V2X and machine-to-machine (M2M) communications, a network-side device in a 6G network, a device implementing the functions of a base station in a future communication system, or the like. The base station may be a network supporting the same or different access technologies. The embodiments of the present disclosure are not limited to specific technologies or specific device configurations adopted by the network device.

The base station may be stationary or mobile. For example, a helicopter or an unmanned aerial vehicle (UAV or drone) may be configured to function as the base station, and one or more cells may move according to a position of the mobile base station. In some embodiments, the helicopter or the UAV may be configured to be a device communicating with another mobile base station.

In some deployments, the network device in the embodiments of the present disclosure may refer to the CU or DU, or the network device may include the CU or DU. The gNB may also include the AAU.

The network device and the terminal device may be deployed on land, including indoors or outdoors, and may be handheld or vehicle-mounted; or may be deployed on a water surface; and on an aircraft, a balloon, or a satellite in the air. The scenarios of the network devices and the terminal devices are not limited by the embodiments of the present disclosure.

### Sidelink Communication Under Different Network Coverages

The sidelink communication refers to a communications technology based on the sidelink. The sidelink communication may refer to the D2D or V2X communications. Communication data in a traditional cellular system is transmitted or received between the terminal device and the network device, whereas the sidelink communication supports direct communication data transmission between terminal devices. In comparison to a traditional cellular communication, this direct communication data transmission between terminal devices has an increased spectrum efficiency and a lower transmission latency. For example, the V2X system uses the sidelink communication technology.

In the sidelink communication, depending on the network coverage for the terminal device, the sidelink communication may be categorized into in-coverage sidelink communication, partial-coverage sidelink communication, and out-of-coverage sidelink communication.

FIG. 2 is a schematic diagram of a scenario for in-coverage sidelink communication. In the scenario illustrated in FIG. 2, two terminal devices 120a are both within a coverage range of a network device 110. Therefore, the two terminal devices 120a may both receive configuration signaling (the configuration signaling in the embodiments of the present disclosure may also be referred to as configuration information) from the network device 110, and determine a sidelink configuration based on the configuration signaling from the network device 110. Upon the sidelink configuration, the two terminal devices 120a may perform the sidelink communication on the sidelink.

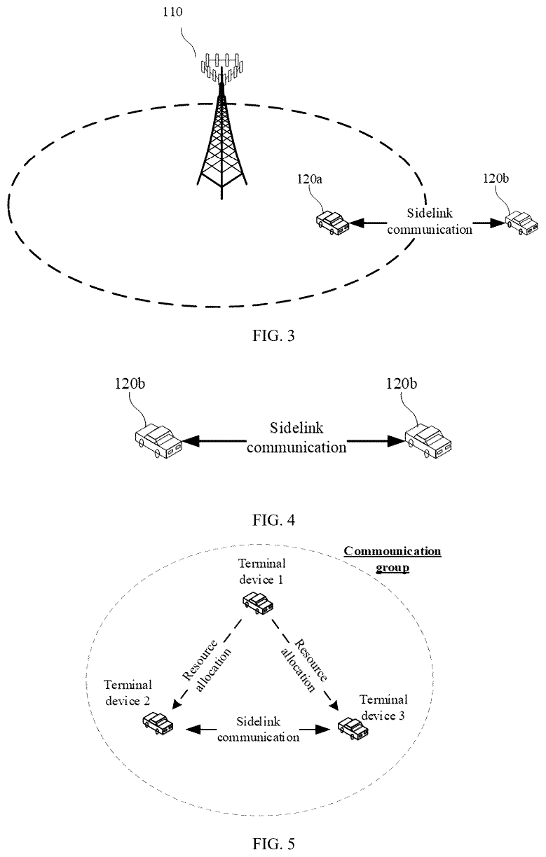

FIG. 3 is a schematic diagram of a scenario for partial-coverage sidelink communication. In the scenario illustrated in FIG. 3, sidelink communication is carried out between a terminal device 120a and a terminal device 120b. The terminal device 120a is within the coverage range of a network device 110. Therefore, the terminal device 120a is capable of receiving configuration signaling from the network device 110, and determine a sidelink configuration based on the configuration signaling from the network device 110. The terminal device 120b is outside the coverage range of the network device 110, and is incapable of receiving configuration signaling from the network device 110. In this scenario, the terminal device 120b may determine a sidelink configuration based on at least one of pre-configuration information or information carried by a physical sidelink broadcast channel (PSBCH) transmitted by the terminal device 120a within the coverage range. Upon the sidelink configuration, both the terminal device 120a and the terminal device 120b may perform the sidelink communication on the sidelink.

FIG. 4 is a schematic diagram of a scenario for out-of-coverage sidelink communication. In the scenario illustrated in FIG. 4, two terminal devices 120b are both outside of the coverage range of a network device 110. In this scenario, the two terminal devices 120b may both determine a sidelink configuration based on pre-configuration information. Upon the sidelink configuration, the two terminal devices 120b may perform the sidelink communication on the sidelink.

### Sidelink Communication Based on Central Control Node

FIG. 5 is a schematic diagram of a scenario for sidelink communication based on a central control node. In this scenario, a plurality of terminal devices may form a communication group, and the communication group contains the central control node. The central control node may be a terminal device within the communication group (e.g., a terminal device 1 in FIG. 5), the terminal device may also be referred to as a cluster head (CH). The central control node may be responsible for implementing one or more of the following functions: establishing the communication group; managing joining and leaving of group members; coordinating resources within the communication group; allocating sidelink transmission resources to other terminal devices; receiving sidelink feedback information from other terminal devices; and coordinating resources with other communication groups.

### Modes of Sidelink Communication

Some standards or protocols, e.g., the 3^{rd} Generation Partnership Project (3GPP), have defined two sidelink communication modes: a first mode and a second mode.

In the first mode, the network device allocates resources to the terminal device (the resources involved in the present disclosure may also be referred to as transmission resources, such as time-frequency resources). The terminal device may transmit data on the sidelink based on the resources allocated by the network device. The network device may allocate resources for single transmission to the terminal device, and may also allocate resources for semi-static transmission to the terminal device. The first mode may be applicable to in-coverage sidelink communication, e.g., the scenario in FIG. 2. In the scenario illustrated in FIG. 2, the terminal device 120a is within the coverage range of the network device 110. Therefore, the network device 110 may allocate the resources for sidelink transmission to the terminal device 120a.

In the second mode, the terminal device may autonomously select one or more resources from a resource pool (RP). Subsequently, the terminal device may perform sidelink transmission based on the selected resources. For example, in the scenario illustrated in FIG. 4, the terminal device 120b is out of coverage, and thus the terminal device 120b may autonomously select resources from a pre-configured resource pool for sidelink transmission. Alternatively, in the scenario illustrated in FIG. 2, the terminal device 120a may also autonomously select one or more resources from the resource pool configured by the network device 110 for sidelink transmission.

### Data Transmission Schemes of Sidelink Communication

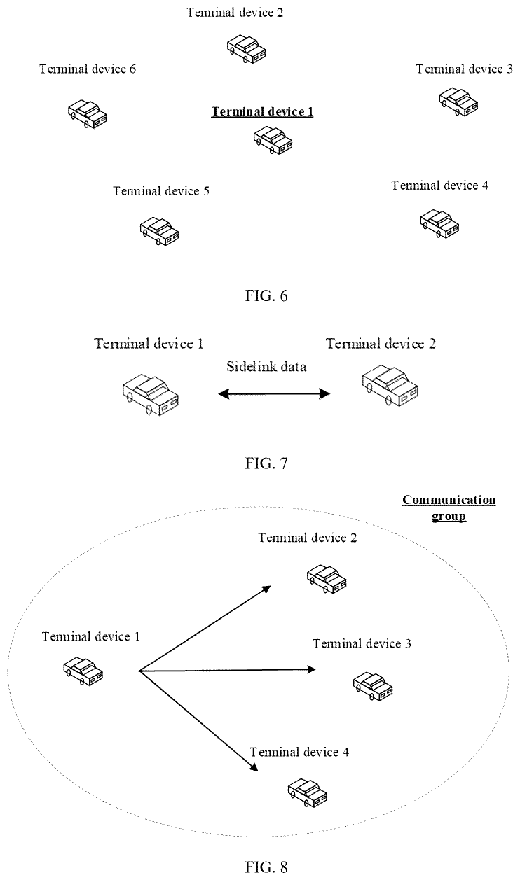

Some sidelink communication systems, e.g., LTE-V2X, support a broadcast-based data transmission scheme (referred to as broadcast transmission). For the broadcast transmission, a receiver terminal may be any terminal device proximate to a transmitter terminal. Using FIG. 6 as an example, a terminal device 1 is the transmitter terminal, and a corresponding receiving terminal is any terminal device around the terminal device 1, such as terminal devices 2 to 6 in FIG. 6.

In addition to the broadcast transmission, some communication systems support a unicast-based data transmission scheme (referred to as unicast transmission) and/or a groupcast-based data transmission scheme (referred to as groupcast transmission). For example, NR-V2X aims to support autonomous driving. Autonomous driving imposes higher requirements upon data interaction between vehicles. For instance, the data interaction between vehicles requires a higher throughput, a lower latency, a greater reliability, a greater coverage, and more flexible resource allocation methods. Therefore, to improve the performance of the data interaction between vehicles, NR-V2X introduces the unicast transmission and the groupcast transmission.

For the unicast transmission, only one terminal device acts as the receiver terminal. Using FIG. 7 as an example, the unicast transmission occurs between the terminal device 1 and the terminal device 2. The terminal device 1 may be the transmitter terminal, while the terminal device 2 may be the receiver terminal, or vice versa.

For the groupcast transmission, the receiver terminal may be any terminal device in a communication group, or the receiver terminal may be any terminal device within a specific transmission distance. Using FIG. 8 as an example, the terminal device 1, the terminal device 2, the terminal device 3, and the terminal device 4 form a communication group. In a case where the terminal device 1 transmits data, all the other terminal devices in the communication group may be receiver terminals.

### Slot Structure for Sidelink Communication

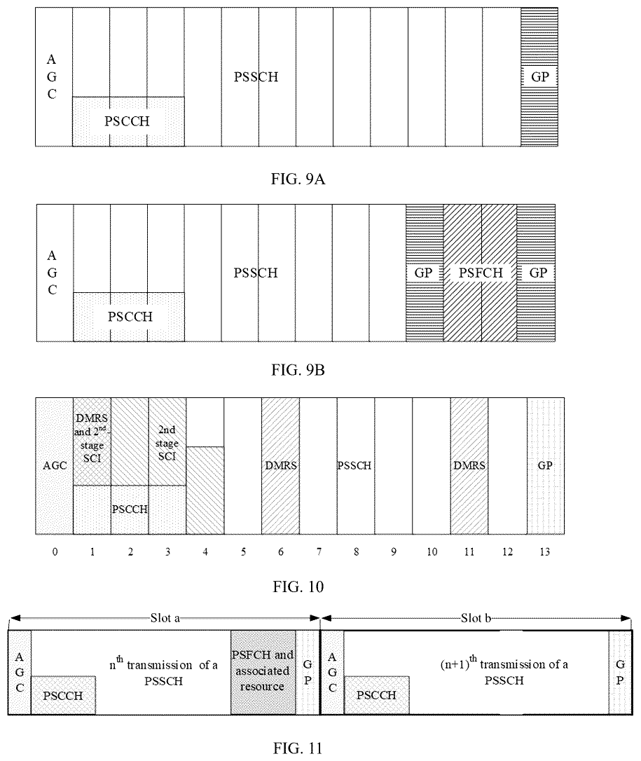

Communication systems may define a frame, a subframe, or a slot structure for the sidelink communication. Some sidelink communication systems define several slot structures. For example, NR-V2X defines two slot structures. One slot structure does not include a physical sidelink feedback channel (PSFCH), as illustrated in FIG. 9; while the other slot structure includes a PSFCH, as illustrated in FIG. 9B.

In NR-V2X, a physical sidelink control channel (PSCCH) may start at a second sidelink symbol of a slot in the time domain, and may occupy two or three symbols in the time domain (the symbols herein refer to orthogonal frequency division multiplexing (OFDM) symbols). The PSCCH may occupy a plurality of physical resource blocks (PRBs). For example, the number of PRBs occupied by the PSCCH may be selected from a set {10, 12, 15, 20, 25}.

To reduce the complexity of blind detection on the PSSCH performed by the terminal device, generally only a specific number of symbols and a specific number of PRBs are configured for the PSCCH within one resource pool. Additionally, since NR-V2X uses a sub-channel as the minimum granularity for PSSCH resource allocation, the number of PRBs occupied by the PSCCH needs be less than or equal to the number of PRBs contained in one sub-channel within the resource pool.

Referring to FIG. 9A, for the slot structure excluding the PSFCH, the PSSCH in NR-V2X may start at the second sidelink symbol of the slot in the time domain. The last sidelink symbol of the slot is used as a guard period (GP), while the remaining sidelink symbols are used to map the PSSCH. A first sidelink symbol of the slot may be a repetition of the second sidelink symbol. In general, the terminal device functioning as the receiver terminal uses the first sidelink symbol as a symbol for automatic gain control (AGC). Therefore, data on first sidelink symbol is generally not used for data demodulation. The PSSCH may occupy K sub-channels in the frequency domain, and each of the K sub-channels may include M contiguous PRBs (the values of K and M may be predefined by a protocol, preconfigured, configured by the network device, or depend on implementation of the terminal device.

FIG. 9B illustrates a slot structure including the PSFCH, which schematically demonstrates the positions of the symbols occupied by the PSFCH, the PSCCH, and the PSSCH in the slot. A main difference from the slot structure in FIG. 9A is that the second-to-last symbol and the third-to-last symbol in the slot are used for transmitting the PSFCH. Additionally, the symbol before the symbols used for transmitting PSFCH is also used as the GP. In the slot structure as illustrated FIG. 9B, the last symbol of the slot is used as the GP, the second-to-last symbol is used for PSFCH transmission, and the data on the third-to-last symbol is the same as the data on the second-to-last symbol used for the PSFCH transmission, i.e., the third-to-last symbol is used for the AGC, and the fourth-to-last symbol has the same function as the last symbol, i.e., used as the GP. In addition, the first symbol of the slot is used for the AGC, the data on the first symbol is the same as the data on the second symbol in the slot. The PSCCH occupies three symbols, and the remaining symbols may be used for the PSSCH transmission. Sidelink PSSCH

In some sidelink communication systems, e.g., NR sidelink (SL) systems, the PSSCH may be used to carry second-stage SCI (2^{nd}-stage SCI) and data information. A format of the 2^{nd} stage SCI may be, for example, SCI 2-A, SCI 2-B, or SCI 2-C.

An encoding scheme of the 2^{nd}-stage SCI may adopt polar code-based coding, and modulation may be performed using a quadrature phase shift keying (QPSK) modulation scheme.

A code rate of the 2^{nd}-stage SCI may be dynamically adjusted within a specific range, and the code rate used for the 2^{nd}-stage SCI may be indicated by 1^{st}-stage SCI. Therefore, even in a case where the code rate of the 2^{nd}-stage SCI changes, the terminal device at a receiver end does not need to perform blind detection on the 2^{nd}-stage SCI. Modulation symbols of the 2^{nd}-stage SCI may be mapped starting from a symbol containing a first DMRS of the PSSCH, in a frequency-first then time-first mapping scheme. In a case where the symbol contains the DMRS, the 2^{nd}-stage SCI may be mapped to resource elements (REs) not occupied by the DMRS. For example, as illustrated in FIG. 10, the 2^{nd}-stage SCI occupies symbols 1 to 4, and the 2^{nd}-stage SCI shares symbol 1 with a first PSCCH DMRS.

The data information of the PSSCH may adopt a low-density parity-check (LDPC) encoding scheme. Additionally, the highest modulation order currently supported by the PSSCH is 256 quadrature amplitude modulation (QAM).

Within one resource pool, the data information of the PSSCH may adopt several different modulation and coding scheme (MCS) tables. The several different MCS tables may include, for example, a conventional 64QAM MCS table, a 256QAM MCS table, and a low-spectral-efficiency 64QAM MCS table. During the transmission of the PSSCH, the MCS table adopted by the terminal device at the transmitter end may be indicated by an “MCS table indicator” field in the 1^{st}-stage SCI.

For controlling a peak-to-average power ratio (PAPR), the PSSCH is typically transmitted on contiguous PRBs. In the NR SL system, the sub-channel is a smallest frequency-domain resource granularity of the PSSCH. Therefore, the NR SL system typically requires that the PSSCH occupy contiguous sub-channels for controlling the PARP.

Furthermore, in the NR SL system, the PSSCH supports up to dual-stream transmission and adopts an identity precoding matrix to map data on two transport layers corresponding to the dual streams to two antenna ports. At present, at most one transport block (TB) may be transmitted in the PSSCH. In a case where the PSSCH adopts the dual-stream transmission, modulation symbols of the 2^{nd}-stage SCI on the two streams may be identical, and such a design may ensure the reception performance of the 2^{nd}-stage SCI in a highly correlated channel.

In the NR SL system, the maximum number of retransmissions for the PSSCH is 32. Therefore, in a case where the resource pool contains PSFCH resources and a configuration period of the PSFCH resources is 2 or 4, the number of available symbols in the slot containing the PSSCH may change for multiple transmissions of the same PSSCH. For example, referring to FIG. 11, the PSSCH performs an n^{th} transmission in slot a and performs an (n+1)^{th} transmission in slot b. As illustrated in FIG. 11, the PSFCH resources and the corresponding related resources (e.g., the AGC symbol and the GP symbol corresponding to the PSFCH) are present in slot a, while the PSFCH is not present in slot b. Therefore, due to the change in the PSFCH resources, the numbers of available symbols in the slots are different in the n^{th} transmission and the (n+1)^{th} transmission. The change in the available symbols in a slot causes a change in a transport block size (TBS) corresponding to the PSSCH. Therefore, to ensure that the TBS remains unchanged during multiple transmissions, the actual number of PSFCH symbols may not be used when calculating the TBS. Instead, the number of PSFCH symbols used for calculating the TBS is determined based on indication information in the 1^{st}-stage SCI.

### Sidelink TBS

In some sidelink communication systems (e.g., the NR SL system), the PSSCH adopts a TBS determination mechanism for a physical downlink shared channel (PDSCH) and a physical uplink shared channel (PUSCH) in an NR system, i.e., the TBS is determined based on a reference value of the number of REs used for the PSSCH in the slot containing the PSSCH, such that an actual code rate approaches as much as possible to a target code rate. That is, upon determining the TBS, such sidelink communication systems do not use the actual number of REs occupied by the PSSCH, but use the reference value of the number of REs occupied by the PSSCH. The purpose is to ensure that the number of REs used for determining the TBS remains unchanged during the retransmission of the PSSCH, such that the TBSs determined for different transmission processes of the PSSCH are identical. The reference value of the number of REs occupied by the PSSCH may be determined based on Formula (1):

$${N}_{RE} = {N}_{RE}^{′} \cdot {n}_{PRB} - {N}_{RE}^{SCI , 1} - {N}_{RE}^{SCI , 2} \qquad ( 1 )$$

In Formula (1), n_{PRB} represents the number of PRBs occupied by the PSSCH;

$${N}_{RE}^{SCI , 1}$$

represents the number of REs occupied by the 1^{st}-stage SCI (and may include the number of REs occupied by the DMRS of the PSCCH);

$${N}_{RE}^{SCI , 2}$$

represents the number of RES occupied by the 2^{nd}-stage SCI, and

$${N}_{R E}^{′}$$

represents the reference number of the REs that may be used for the PSSCH within one PRB.

$${N}_{RE}^{′}$$

may be determined based on Formula (2):

$${N}_{RE}^{′} = {N}_{sc}^{RB} ( {N}_{symb}^{sh} - {N}_{symb}^{PSFCH} ) - {N}_{oh}^{PRB} - {N}_{RE}^{DMRS} \qquad ( 2 )$$

In Formula (2),

$${N}_{sc}^{RB}$$

represents the number of the subcarriers within one PRB, wherein the value of

$${N}_{sc}^{RB}$$

is typically 12;

$${N}_{symb}^{s ℏ}$$

represents the number or symbols within one slot that may be used for the sidelink transmission,

$${N}_{symb}^{s ℏ}$$

typically does not include the first symbol (i.e., the GP symbol) and the last symbol (i.e., the symbol used for the AGC) symbol of the slot, and using the slot structure in FIG. 10 as an example,

$${N}_{symb}^{s ℏ} = 12 ; {N}_{symb}^{PSFCH}$$

represents the reference value of the number of symbols occupied by the PSFCH, wherein the value of

$${N}_{symb}^{PSFCH}$$

may be represent by the “PSFCH symbol number” in the 1^{st}-stage SCI, and the value of

$${N}_{symb}^{PSFCH}$$

is typically 0 or 3;

$${N}_{0 ℏ}^{PRB}$$

represents the reference value of a phase tracking reference signal (PTRS) and a CSI-RS, wherein the value of

$${N}_{0 ℏ}^{PRB}$$

may be configured by a radio resource control (RRC) reference value; and

$${N}_{RE}^{DMRS}$$

represents the average number of REs within the slot in a DMRS pattern. As illustrated in Table 1, wherein value of

$${N}_{RE}^{DMRS}$$

is associated with the DMRS pattern supported within the resource pool, and referring to Table 1, in a case where the DMRS pattern includes three patterns {2, 3, 4}, the value of

$${N}_{RE}^{DMRS}$$

is 18, i.e., the average number of REs associated with the three DMRS patterns is 18.

TABLE 1
$Correspondence between DMRS patterns and {N}_{R E}^{D M R S}$
within the resource pool

| DMRS pattern | N_{RE}^{DMRS} |
|---|---|
| {2} | 12 |
| {3} | 18 |
| {4} | 24 |
| {2, 3} | 15 |
| {2, 4} | 18 |
| {3, 4} | 21 |
| {2, 3, 4} | 18 |

### Sidelink DMRS

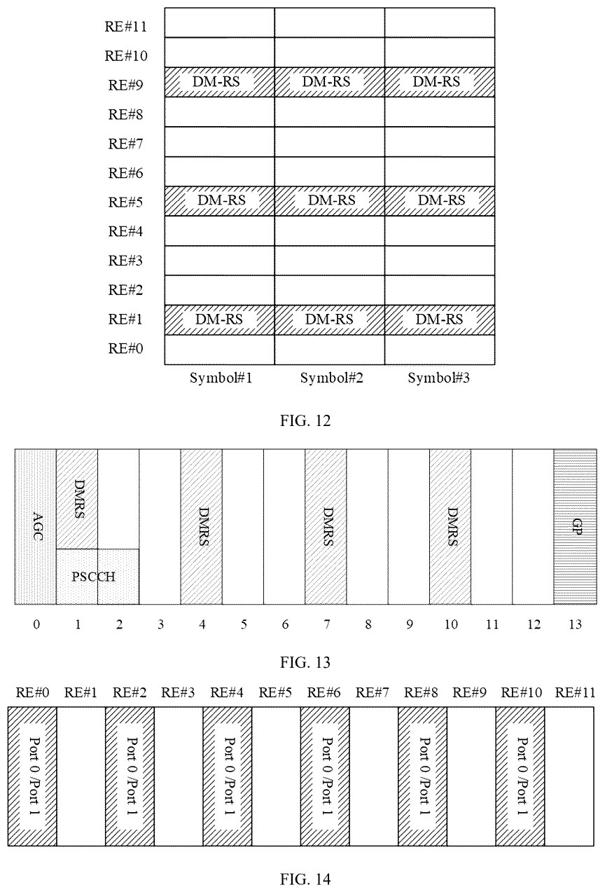

In the NR SL system, the DMRS pattern of the PSCCH and the DMRS pattern of the PDCCH in the NR system are the same, i.e., the DMRS is present on each symbol of the PSCCH, and is located on the REs corresponding to a set {#1, #5, #9} within the PRB in the frequency domain, as illustrated in FIG. 12.

A DMRS sequence of the PSCCH may be generated from Formula 3:

$${r}_{l} ( m ) = \frac{1}{\sqrt{2}} ( 1 - 2 c ( m ) ) + j \frac{1}{\sqrt{2}} ( 1 - 2 c ( m + 1 ) ) \qquad ( 3 )$$

In Formula (3), c(m) represents a pseudo-random sequence, wherein the pseudo-random sequence may be initiated from formula (4):

$${c}_{init} = ( {2}^{17} ( {N}_{symb}^{slot} {n}_{s , f}^{μ} + 1 + 1 ) ( 2 {N}_{ID} + 1 ) + 2 {N}_{ID} ) mod {2}^{31} \qquad ( 4 )$$

In Formula (4), l represents an index of the symbol within the slot containing the DMRS;

$${n}_{s , f}^{μ}$$

represents an index of a system frame within the slot containing the DMRS; and

$${N}_{s y m b}^{slot}$$

represents the number of symbols within the slot. N_{ID}∈{0, 1, . . . , 65535}, wherein the value of N_{ID} may be configured or preconfigured by a network device.

The PSSCH in the NR SL system adopts the design of the NR air interface (i.e., a Uu interface), that is, multiple time-domain PSSCH DMRS patterns are adopted. Within the resource pool, the number of DMRS patterns that may be used is associated with the number of symbols of the PSSCH (including the first AGC symbol) within the resource pool. For the specific number of PSSCH symbols and the specific number of PSCCH symbol, the available DMRS patterns and a position of each DMRS symbol within the DMRS pattern may be determined based on Table 2.

TABLE 2
Number of DMRS symbols and symbol positions contained in the
slot under different numbers of PSSCH and PSCCH symbols

| Number of | DMRS symbol position (relative to the first | | | | | |
|---|---|---|---|---|---|---|
| PSSCH | AGC symbol position) | | | | | |
| symbols | Number of PSCCH | | | Number of PSCCH | | |
| (including | symbols is 2 | | | symbols is 3 | | |
| the first AGC | Number of DMRS symbols | | | Number of DMRS symbols | | |
| symbols) | 2 | 3 | 4 | 2 | 3 | 4 |
| 6 | 1, 5 | | | 1,5 | | |
| 7 | 1, 5 | | | 1, 5 | | |
| 8 | 1, 5 | | | 1, 5 | | |
| 9 | 3, 8 | 1, 4, 7 | | 4, 8 | 1, 4, 7 | |
| 10 | 3, 8 | 1, 4, 7 | | 4, 8 | 1, 4, 7 | |
| 11 | 3, 10 | 1, 5, 9 | 1, 4, 7, 10 | 4, 10 | 1, 5, 9 | 1, 4, 7, 10 |
| 12 | 3, 10 | 1, 5, 9 | 1, 4, 7, 10 | 4, 10 | 1, 5, 9 | 1, 4, 7, 10 |
| 13 | 3, 10 | 1, 6, 11 | 1, 4, 7, 10 | 4, 10 | 1, 6, 11 | 1, 4, 7, 10 |

Using the case where the number of PSSCH symbols is 13 as an example, referring to FIG. 13, in a case where the number of DMRS symbols is 4, the four DMRS symbols respectively occupy the 1^{st}, 4^{th}, 7^{th}, and 10^{th} symbol positions (or symbol indexes) in the slot.

In a case where multiple DMRS patterns are configured in the time domain within the resource pool, a specifically adopted DMRS pattern may be selected by the terminal device at the transmitter end and indicated in the 1^{st}-stage SCI. Such a design allows the terminal device moving at a high speed to select a high-density DMRS pattern, thereby ensuring channel estimation accuracy; and correspondingly, in a case where the terminal device moves at a low speed, a low-density DMRS pattern may be adopted, thereby improving spectral efficiency.

The generation scheme of the PSSCH DMRS sequence is similar to the generation scheme of the PSCCH DMRS sequence, with the difference being the value of N_{ID} in the initiation formula for the pseudo-random sequence c(m) (corresponding to Formula (4)). In the pseudo-random sequence c(m) to generate the PSSCH DMRS,

$${N}_{ID} = {\sum }_{i = 0}^{L - 1} {p}_{i} \cdot {2}^{L - 1 - i} .$$

pᵢ represents an i^{th} cyclic redundancy check (CRC) of the PSCCH that schedules the PSSCH. L represents the number of bits for the PSCCH CRC, and is typically 24.

In the NR system, the PDSCH and the PUSCH support two frequency-domain DMRS patterns, specifically, DMRS frequency-domain Type 1 and DMRS frequency-domain Type 2. Furthermore, for each frequency-domain type of the DMRS, two different symbol types exist: single-symbol type and double-symbol type. Single-symbol DMRS frequency-domain Type 1 may support four DMRS ports. Single-symbol DMRS frequency-domain Type 2 may support six DMRS ports. The DMRS ports supported by the double-symbol DMRS frequency-domain Type 1 are twice the number of DMRS ports supported by the single-symbol DMRS frequency-domain Type 1. The DMRS ports supported by double-symbol DMRS frequency-domain Type 2 are twice the number of DMRS ports supported by the single-symbol DMRS frequency-domain Type 2. However, in some sidelink communication systems (e.g., NR SL systems), the PSSCH needs to support at most two DMRS ports; and therefore, these communication systems typically only support single-symbol DMRS frequency-domain Type 1. A frequency-domain pattern of this type of the DMRS is illustrated in FIG. 14.

### Sidelink CSI-RS

For better support for unicast communication, the NR-V2X system supports a sidelink CSI-RS (SL CSI-RS). The NR-V2X system specifies that the SL CSI-RS is only transmitted in a case where three conditions are satisfied.

Condition 1: The terminal device needs to transmit the PSSCH corresponding to the SL CSI-RS, that is, the terminal device is not allowed to transmit SL CSI-RS by itself.

Condition 2: A sidelink CSI report is activated via a higher layer signaling.

Condition 3: In a case where the higher layer signaling activates the sidelink CSI report, a corresponding bit in the 2^{nd}-stage SCI initiates the sidelink CSI report.

The maximum number of ports supported by the SL CSI-RS is 2. In a case where there are two ports, the SL CSI-RS from different ports is multiplexed via code division on two adjacent REs of the same sidelink symbol. Within the PRB, the number of the SL CSI-RS of each port is 1, i.e., the density is 1. Therefore, within a PRB, the SL CSI-RS appears on at most one sidelink symbol, and a specific position of the sidelink symbol is determined by the terminal device transmitting the SL CSI-RS.

Usually, to avoid affecting a resource mapping of the PSCCH and the 2^{nd}-stage SCI, the SL CSI-RS may not be located on the same sidelink symbol as the PSCCH and the 2^{nd}-stage SCI.

Additionally, since the channel estimation accuracy of the sidelink symbol containing the PSSCH DMRS is relatively high, and the SL CSI-RSs from two ports need to occupy two contiguous REs in the frequency domain, the SL CSI-RS may not be transmitted on the same sidelink symbol as the PSSCH DMRS.

In some cases, the position of the sidelink symbol occupied by the SL CSI-RS may be indicated by sl-CSI-RS-FirstSymbol in PC5 RRC. Furthermore, the position of a first RE within one PRB occupied by the SL CSI-RS is indicated by an “sl-CSI-RS-FreqAllocation” parameter in the PC5 RRC. In a case where the SL CSI-RS corresponds to one port, the parameter is a bit pattern with a length of 12, and corresponds to 12 REs within one PRB. In a case where the SL CSI-RS corresponds to two ports, the parameter is a bit pattern with a length of 6, and the SL CSI-RS occupies two REs, 2f(1) and 2f(1)+1, wherein f(1) represents an index of a bit with a value of 1 in the bitmap above.

A frequency-domain position occupied by the SL CSI-RS is also determined by the terminal device transmitting the SL CSI-RS. It should be noted that the frequency-domain position of the SL CSI-RS may not interfere with a frequency-domain position occupied by a PT-RS.

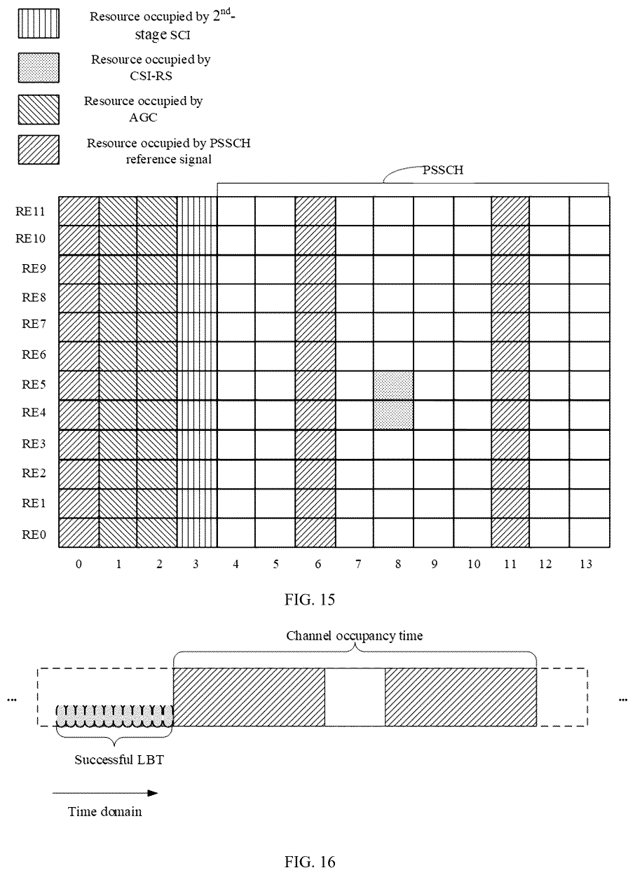

FIG. 15 is a schematic diagram of a time-domain resource occupied by the SL CSI-RS. Referring to FIG. 15, it is assumed that the number of ports corresponding to the SL CSI-RS is 2, SL-CSI-RS-FirstSymbol indicates position 8 of the sidelink symbol occupied by the SL CSI-RS, sl-CSI-RS-FreqAllocation indicates a position of the first RE within one PRB occupied by the SL CSI-RS is [b₅, b₄, b₃, b₂, b₁, b₀]=[0,0,0,1,0,0].

### Unlicensed Spectrum and Channel Sensing

An unlicensed spectrum is a spectrum allocated by countries and regions that may be used for a wireless device communication, and the spectrum is typically considered shared spectrum. That is, the communication device may use the spectrum without applying for an exclusive spectrum authorization from the government as long as the communication device in the same or different communication system meets regulatory requirements set by the country or the region on the spectrum.

To allow various communication devices (or communication systems) carrying out wireless communication using the unlicensed spectrum to coexist harmoniously on the unlicensed spectrum, some countries or regions specify regulatory requirements that need to be met for using the unlicensed spectrum. For example, the communication device needs to follow an LBT mechanism. The LBT specifies that, prior to performing signal transmission on a channel of the unlicensed spectrum, the communication device needs to perform channel sensing. In a case where a channel sensing result indicates that the channel is idle, the communication device may perform the signal transmission using the channel of the unlicensed spectrum. In a case where the channel sensing result indicates that the channel is busy, the communication device is usually not allowed to perform the signal transmission using the channel of the unlicensed spectrum to perform the signal transmission. For fairness, in one transmission, a duration for which the communication device uses the channel of the unlicensed spectrum for signal transmission may not exceed a maximum channel occupancy time (MCOT). FIG. 16 illustrates an example of the channel occupancy time obtained following successful LBT on the channel of unlicensed spectrum and an example of the signal transmission using the resources within the channel occupancy time.

Although the channel sensing based on the LBT is not a globally mandated regulatory requirement, the channel sensing offers benefits such as avoiding interference and achieving harmonious coexistence for the communication transmission between systems sharing the same spectrum. Therefore, during design of NR systems operating in the unlicensed spectrum, the communication device in the system is required to support the channel sensing. From the perspective of network deployment, the channel sensing includes two mechanisms: load-based equipment (LBE) LBT, also referred to as dynamic channel sensing or dynamic channel occupancy; and frame-based equipment (FBE) LBT, also referred to as semi-static channel sensing or semi-static occupancy.

The following describes the different types of LBT schemes (i.e., the different types of channel access schemes)

Type 1 LBT scheme may also be referred to as multi-slot channel sensing with random backoff based on an adjustable contention window size. In Type 1 LBT, the communication device may initiate a channel occupancy of a duration T_{mcot} based on a channel access priority p. The following table lists the channel access priorities and corresponding parameters of the terminal devices when performing Type 1 LBT scheme.

TABLE 3
Channel access parameters corresponding
to different channel priorities

| Channel | | | | | |
|---|---|---|---|---|---|
| access | | | | | Allowed |
| priority (p) | mₚ | CW_{min, p} | CW_{max, p} | T_{mcot, p} | CWₚ value |
| 1 | 2 | 3 | 7 | 2 ms | {3, 7} |
| 2 | 2 | 7 | 15 | 4 ms | {7, 15} |
| 3 | 3 | 15 | 1023 | 6 or 10 ms | {15, 31, 63, 127, |
| | | | | | 255, 511, 1023} |
| 4 | 7 | 15 | 1023 | 6 or 10 ms | {15, 31, 63, 127, |
| | | | | | 255, 511, 1023} |

In Table 3, mₚ represents the number of backoff slots corresponding to the channel access priority p, CWₚ represents the contention window size corresponding to the channel access priority p, CW_{min,p} represents a minimum value of CWₚ corresponding to the channel access priority p, CW_{max,p} represents a maximum value of CWₚ corresponding to the channel access priority, T_{mcot,p} represents a maximum length of the channel occupancy time corresponding to the channel access priority p. The four types of channel access priorities listed in Table 3, p=1 is the highest priority.

In a case where the network device adopts Type 1 LBT scheme, other than transmitting its own data, the network device may also share the channel occupancy time (COT) with the terminal device. Accordingly, in a case where the terminal device adopts Type 1 LBT scheme, other than transmitting its own data, the terminal device may also share the COT with the network device or other terminal devices. Sharing the resource within the COT to perform channel access may be accomplished by adopting Type 2 LBT scheme. Type 2 LBT scheme may also be referred to as a channel access scheme based on a fixed-length channel sensing slot. Type 2 LBT scheme includes Type 2A LBT scheme, Type 2B LBT scheme, and Type 2C LBT scheme.

In Type 2A LBT scheme, the communication device may use 25-μs channel sensing. That is, the communication device may begin the channel sensing 25 μs before data transmission. The 25-μs channel sensing may include 16-μs channel sensing and 9-μs channel sensing. In a case where both channel sensing indicates that the channel is idle, the channel is considered idle and the channel access may be performed.

In Type 2B LBT scheme, the communication device may use 16-μs channel sensing. During the channel sensing process, in a case where the communication device senses that there is at least 5 μs of channel idle time within 26 μs, and that there is more than 4 μs of idle time within the last 9 μs, the channel is considered idle.

In Type 2C LBT scheme, the communication device may directly transmit the data on the channel without performing channel sensing. In Type 2C LBT scheme, a time difference between a current transmission and a previous transmission is less than or equal to 16 μs. That is, in a case where the time difference is less than or equal to 16 μs, the two transmissions are considered as the same transmission, and thus the channel sensing is not required. It should be noted that the transmission duration of the transmission device is limited in Type 2C LBT scheme, typically not exceeding 584 μs

### Channel Access Parameter Indication (Including Cyclic Prefix Extension (CPE)

In a new radio unlicensed system, in a case where the terminal device is scheduled for transmission of the PUSCH or a physical uplink control channel (PUCCH), the network device may indicate the channel access scheme corresponding to the PUSCH or the PUCCH using downlink control information of an uplink grant (UL grant) or a downlink grant (DL grant). Due to some channel schemes need to meet the 16-μs or 25-μs slot requirement, the terminal device may ensure the slot size between the two transmissions by adopting a scheme to transmit the CPE. Correspondingly, the network device may indicate a CPE length of a first symbol of the uplink transmission from the terminal device.

The network device may explicitly indicate the CPE length, the channel access scheme, or the channel access priority to the terminal device by means of joint coding.

The following describes indication schemes of channel parameters introduced under different DCI formats.

### First Format: Fallback UL Grant (DCI Format 0_0) Scheduling the PUSCH Transmission

As illustrated in Table 4, a set of join indications for the channel access scheme and the CPE length is preset in the standard. The fallback UL grant includes 2-bit LBT indication information, and the 2-bit LBT information is used to indicate a jointly coded channel access scheme and CPE length from the set listed in Table 4. In a case where the channel access scheme is Type 1 channel access, the terminal device autonomously selects a channel access priority class (CAPC) based on a service priority.

### Second Format: Fallback DL Grant (DCI Format 1_0) Scheduling the PDSCH Transmission

As listed in Table 4, a set of joint indications for the channel access scheme and the CPE length is preset in the standard. The fallback DL grant includes 2-bit LBT indication information, wherein the 2-bit LBT information is used to indicate a jointly coded channel access scheme and CPE length from the set listed in Table 4. The channel access scheme and CPE length are used for the PUCCH transmission. The PUCCH may carry an acknowledgement (ACK) or a negative acknowledgement (NACK) corresponding to the PDSCH. In a case where the channel access scheme is Type 1 channel access, the terminal device determines a CAPC=1 for transmitting the PUCCH.

TABLE 4
joint indication set for the channel access scheme and CPE length

| LBT | | |
|---|---|---|
| indication | Channel access scheme | CPE length |
| 0 | Type 2C channel access | C2 * symbol length-16 μs-TA |
| 1 | Type 2B channel access | C3 * symbol length-25 μs-TA |
| 2 | Type 2A channel access | C1 * symbol length-25 μs |
| 3 | Type 1 channel access | 0 |

In Table 4, a value of C1 is defined by a protocol. In a case where a subcarrier spacing is 15 kHz or 30 kHz, C1=1. In a case where the subcarrier spacing is 60 kHz, C2=2. Values of C2 and C3 are configured by the higher layer parameter. In a case where the subcarrier spacing is 15 kHz or 30 kHz, the values of C2 and C3 range from 1 to 28. In a case where the subcarrier spacing is 60 kHz, the values of C2 and C3 range from 2 to 28.

### Third Format: Non-Fallback UL Grant (DCI Format 0_1) Scheduling the PUSCH Transmission

A higher layer configures an LBT parameter indication set. The LBT parameter indication set includes at least one jointly coded channel access scheme, CPE length, and CAPC. The non-fallback UL grant includes the LBT indication information, and the LBT indication information is used to indicate the jointly coded channel access scheme, CPE length, and CAPC in the LBT parameter indication set. The channel access scheme, CPE length, and CAPC are used for the PUSCH transmission. In a case where the indicated channel access scheme is Type 2 channel access, the CAPC indicated simultaneously is the CAPC used by the network device upon acquiring the COT. The LBT indication information includes at most 6 bits.

### Fourth Format: Non-Fallback DL Grant (DCI Format 1_1) Scheduling the PDSCH Transmission

A higher layer configures an LBT parameter indication set. The LBT parameter indication set includes at least one jointly coded channel access scheme and CPE length. The non-fallback DL grant includes the LBT indication information, and the LBT indication information is used to indicate the jointly coded channel access scheme and CPE length. The channel access scheme and CPE length are used for the PUCCH transmission, wherein the PUCCH may carry the ACK or NACK corresponding to the PDSCH. In a case where the channel access scheme is Type 1 channel access, the terminal device determines a CAPC=1 for transmitting the PUCCH. The LBT indication information includes at most 4 bits.

In addition to the above explicit indication, the network device may also implicitly indicate the channel access scheme within the COT. For example, in a case where the terminal device receives the UL grant or DL grant from the network device, wherein the UL grant or DL grant indicates that the channel access type corresponding to the PUSCH or PUCCH is Type 1 channel access, where the terminal device is capable of determining that transmission time of the PUSCH or PUCCH is within the COT of the network device, the terminal device may update the channel access type corresponding to the PUSCH or PUCCH to Type 2A channel access instead of Type 1 channel access.

### Sidelink Power Control

The NR SL system supports an open loop control on the transmit powers of the PSSCH, the PSCCH, the PSFCH, and a sidelink synchronization signal block (S-SSB). For the PSSCH and the PSCCH transmission in a unicast scenario, three control schemes may be supported: power control based on only downlink pathloss, power control based only on sidelink pathloss, and power control based on both downlink pathloss and sidelink pathloss. Which of the three power control schemes needs to be adopted in practice by the PSSCH and the PSCCH may be determined by a higher-layer (RRC) configuration. For example, in a case where the higher layer only configures a basic operating point P_{0,SL} for the power control using the sidelink pathloss, the power control is based only on the sidelink pathloss; or in a case where the higher layer only configures a basic operating point P_{0,D}, for the power control using downlink pathloss, the power control is based on the downlink pathloss; or in a case where the higher layer configures both P_{0,SL} and P_{0,D}, the power control is based on both the downlink pathloss and the sidelink pathloss.

For the transmission of the PSFCH and the S-SSB, as well as the transmission of the PSSCH and the PSCCH in a groupcast scenario and a broadcast scenario, only the open loop power control based on the downlink pathloss is supported because the terminal device serving as the transmitter end has not acquired sidelink pathloss information.

In the LTE-V2X system, the PSCCH and the PSSCH are frequency division multiplexed. Unlike the LTE-V2X, in the NR-V2X system, transmission resources for the PSCCH are embedded in the transmission resources of the PSSCH. The LTE-V2X system applies a 3-dB power boost on the PSCCH to improve the detection performance of the PSCCH. In the NR-V2X, in a case where the 3-dB power boost is applied on the PSCCH via the scheme in the LTE-V2X, the PSSCH power of each resource element on time-domain symbols containing the PSCCH is inconsistent with the PSSCH power of each resource element on time-domain symbols not containing the PSCCH, which degrades the demodulation performance of the PSSCH. Considering that in the NR-V2X system, a code rate of the PSCCH channel may be changed by configuring the number of symbols and the number of PRBs occupied by the PSCCH such that the demodulation performance of the PSCCH is ensured. Therefore, in the NR-V2X system, the 3-dB power boost is not applied to the PSCCH.

### PSSCH/PSCCH Power Control

The PSSCH transmit power on the symbols containing only the PSSCH may be determined as follows:

In a case where the terminal device is operating in the second mode (Mode 2), and the higher layer has configured congestion control, the PSSCH transmit power satisfies the following formula:

$${P}_{PSSCH} = min ( {P}_{C MAX} , {P}_{MAX\_CBR} , min ( {P}_{PSSCH , D} , {P}_{PSSCH , SL} ) ) [ dBm ] ;$$

Otherwise, the PSSCH transmit power satisfies the following formula:

$${P}_{PSSCH} = min ( {P}_{C MAX} , min ( {P}_{PSSCH , D} , {P}_{PSSCH , SL} ) ) [ dBm ] .$$

In the above formulas, P_{CMAX} represents a configured maximum transmit power; P_{MAX_CBR} represents a maximum transmit power determined based on a transmission priority and a channel busy ratio (CBR) under the congestion control configured by the higher layer; and P_{PSSCH,D} and P_{PSSCH,SL} respectively represent the transmit power determined based on the downlink pathloss and the transmit power determined based on the sidelink pathloss.

P_{PSSCH,D} and P_{PSSCH,SL} are respectively determined by the following formulas:

$${P}_{PSSCH , D} ( i ) = {P}_{0 , D} + 10 {log}_{10} ( {2}^{μ} \cdot {M}_{R B}^{P S S C H} ) + {α}_{D} \cdot {PL}_{D} [ dBm ] ; and$$

$${P}_{P S SCH , SL} ( i ) = {P}_{0 , SL} + 10 {log}_{10} ( {2}^{μ} \cdot {M}_{R B}^{P S S C H} ) + {α}_{S L} \cdot {PL}_{S L} [ dBm ] .$$

In the above formulas, P_{0,D}/P_{0,SL} respectively represent a transmit power basic operating point of the power control based on a downlink/sidelink pathloss; α_{D}/α_{SL} represent compensation factors of the downlink/sidelink pathloss configured by the higher layer, wherein in a case where the higher layer does not configure α_{D}/α_{SL}, the values of α_{D}/α_{SL} may be 1; PL_{D}/PL_{SL} represent the downlink/sidelink pathloss estimated by the terminal device; and

$${M}_{R B}^{P S S C H}$$

represents the number of PRBs occupied by the PSSCH on a symbol that does not contain the PSCCH.

It should be noted that in a case where the higher layer configures only POD but not P_{0,SL}, the power control is only based on the downlink pathloss and min (P_{PSSCH,D}, P_{PSSCH,SL})=P_{PSSCH,D}. In a case where the higher layer configures only P_{0,SL} but not POD, the power control is only based on the sidelink pathloss and min (P_{PSSCH,D}, P_{PSSCH,SL})=P_{PSSCH,SL}.

For symbols containing the PSCCH and the PSSCH, the terminal device may allocate the total transmit power P_{PSSCH} to the PSCCH and the PSSCH based on a ratio of PRBs of the PSCCH and the PSSCH.

For example, the PSSCH transmit power P_{PSSCH2} satisfies:

$${P}_{PSSCH 2} = 10 {log}_{10} ( \frac{{M}_{R B}^{P S S C H} - {M}_{R B}^{P S C C H}}{{M}_{R B}^{P S S C H}} ) + {P}_{PSSCH} [ dBm ] .$$

In the above formula,

$${M}_{R B}^{P S C C H}$$

represents the number of PRBs occupied by the PSCCH.

Correspondingly, the PSCCH transmit power satisfies:

$${P}_{PSCC H} = 10 {log}_{10} ( \frac{{M}_{R B}^{P S C C H}}{{M}_{R B}^{P S S C H}} ) + {P}_{PSCC H} [ dBm ] .$$

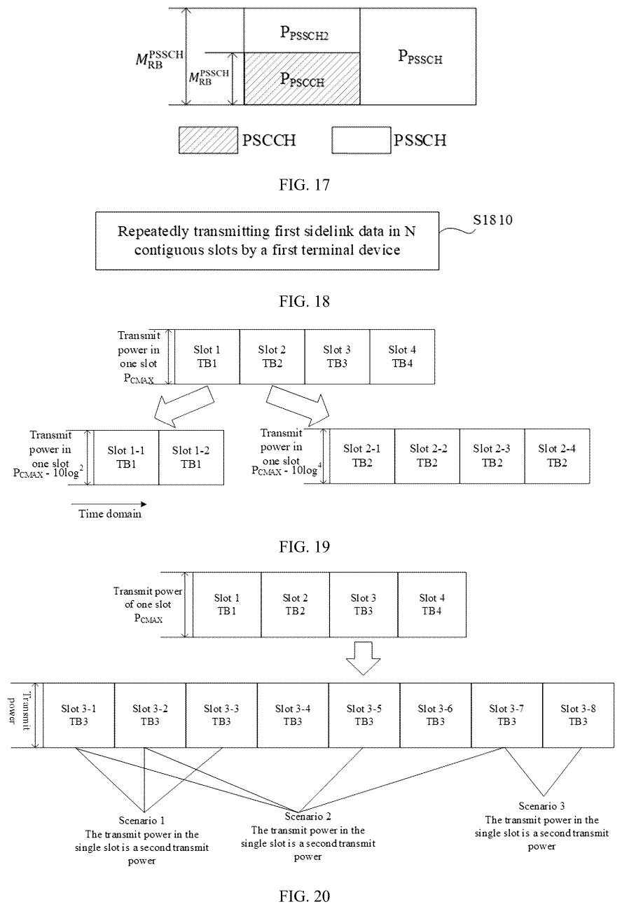

As described above, regarding one PSSCH transmission, the transmit power on each resource element of the PSSCH are equal. FIG. 17 is a distribution of the total PSSCH transmit power on the time-domain symbols containing the PSCCH and the time-domain symbols not containing the PSCCH.

In the sidelink communication system, the PSCCH and the PSSCH are transmitted in a same slot, and the transmission granularity is one slot. Therefore, during the power control, in a case where the transmit power for a current slot is already determined, the transmit power on each OFDM symbol in the current slot is definite, as illustrated in FIG. 17.

The conventional transmit scheme illustrated in FIG. 17 imposes a relatively high requirement for the transmit power, which leads to the terminal device consuming a large amount of power. Some terminal devices (e.g., reduced-capability terminal devices) usually have difficulty in meeting the transmit power requirement. Alternatively, meeting the transmit power requirement increases use cost of the terminal device (e.g., reduced-capability terminal device). However, in a case where the transmit power of the sidelink transmission is reduced, the coverage performance may be decreased (or reception performance of the sidelink data may be affected). Therefore, in the sidelink data transmission, how to both ensure the coverage performance and reduce the power consumption of the terminal device is an issue that needs to be solved.

To address this issue, the following embodiments of the present disclosure are described in detail herein.

FIG. 18 is a schematic flowchart of the sidelink transmission method according to some embodiments of the present disclosure. FIG. 18 is described from the perspective of a first terminal device, wherein the first terminal device may be any type of terminal device that supports sidelink communication. In some embodiments, the first terminal device may be a reduced capability terminal device. For example, the first terminal device may be a terminal device imposing a relatively high requirement on power saving. Additionally, the sidelink transmission method illustrated in FIG. 18 may be applicable to a licensed spectrum, or an unlicensed spectrum.

Referring to FIG. 18, in S1810, the first terminal device repeatedly transmits first sidelink data in N contiguous slots. The embodiments of the present disclosure do not limit a value of N. N may be a positive integer greater than 1. For example, N may take any value between 2 and 4. Naturally, in a special case, N may also be equal to 1. In such a case where N is equal to 1, the first terminal transmits the first sidelink data in only a single slot, similar to the related arts. The value of N may be determined by at least one of: preconfigured information, configuration information of the network device, or indication information of a second terminal device.

The first sidelink data may refer to a TB. That is, the first terminal device may repeatedly transmit the same TB in the N contiguous slots. The TB may be carried in the PSSCH; and therefore, N PSSCHs may be transmitted in the N contiguous slots, wherein the each of the N PSSCHs carry the same TB.

The first terminal device may control the transmit power (i.e., the power for the first terminal device to transmit the first sidelink data or the PSSCH) in the N contiguous slots, such that the transmit power in each of the N contiguous slots is less than a first transmit power. The first transmit power may refer to a maximum transmit power currently available for the terminal device. The first transmit power may be less than or equal to a maximum transmit power P_{CMAX} allowed or configured by the first terminal device. Alternatively, the first transmit power may be the maximum transmit power P_{CMAX} allowed or configured by the first terminal device. In the embodiments of the present disclosure, lower power is used to transmit the same sidelink data in each of the N contiguous slots, such that power consumption is conserved while ensuring coverage performance.

In some embodiments, the first transmit power may be determined by at least one of: the maximum transmit power P_{CMAX} allowed or configured by the first terminal device, a maximum sidelink transmit power P_{MAX_CBR} determined based on a transmit priority and/or CBR, a transmit power P_{PSSCH,D} determined based on the downlink pathloss, or a transmit power P_{PSSCH,SL} determined based on the sidelink pathloss.

For example, in a case where the first terminal device is operating in Mode 2, and the higher layer has configured congestion control, the first transmit power P_{PSSCH} satisfies the following formula:

$${P}_{PSSCH} = min ( {P}_{C MAX} , {P}_{MAX\_CBR} , min ( {P}_{PSSCH , D} , {P}_{PSSCH , SL} ) ) [ dBm ] ;$$

Otherwise, the first terminal device satisfies the following formula:

$${P}_{PSSCH} = min ( {P}_{C MAX} , min ( {P}_{PSSCH , D} , {P}_{PSSCH , SL} ) ) [ dBm ]$$

P_{PSSCH,D} and P_{PSSCH,SL} may be determined by the following formulas:

$${P}_{PSSCH , D} ( i ) = {P}_{0 , D} + 10 {log}_{10} ( {2}^{μ} \cdot {M}_{R B}^{P S S C H} ) + {α}_{D} \cdot {PL}_{D} [ dBm ] ; and$$

$${P}_{P S SCH , SL} ( i ) = {P}_{0 , SL} + 10 {log}_{10} ( {2}^{μ} \cdot {M}_{R B}^{P S S C H} ) + {α}_{S L} \cdot {PL}_{S L} [ dBm ] .$$

In the above formulas, P_{0,D}/P_{0,SL} represents a basic operating point of the transmit power for the power control based on a downlink/sidelink pathloss configured by the higher layer; α_{D}/α_{SL} represents compensation factors of the downlink/sidelink pathloss configured by the higher layer, wherein in a case where the higher layer does not configure α_{D}/α_{SL}, the values of α_{D}/α_{SL} may be 1; PL_{D}/PL_{SL} represent the downlink/sidelink pathloss estimated by the terminal device; and

$${M}_{R B}^{P S S C H}$$

represents the number or PRBs occupied by the PSSCH on symbols not containing the PSCCH.

It should be noted that in a case where the higher layer only configures P_{0,D} but not P_{0,SL}, the power control is only based on the downlink pathloss and min (P_{PSSCH,D}, P_{PSSCH,SL})=P_{PSSCH,D}. In a case where the higher layer only configures P_{0,SL} but not P_{0,D}, the power control is simultaneously based on the sidelink pathloss and min (P_{PSSCH,D}, P_{PSSCH,SL})=P_{PSSCH,SL}.

The embodiments of the present disclosure do not specifically limit a determination scheme of the transmit power in each of the N contiguous slots. In some embodiments, the transmit power in each of the N contiguous slots is a fixed power and is not associated with the value of N. The fixed power may be determined by at least one of: preconfigured information, configuration information of the network device, or indication information of the second terminal device. In some other embodiments, the transmit power in each of the N contiguous slots may be determined based on the number of slots in the N contiguous slots. For example, in a case where N=2, the transmit power in each of the N contiguous slots may be equal to ½ of the first transmit power. As another example, in a case where N=4, the transmit power in each of the N contiguous slots may be equal to ½, ⅓ or ¼ of the first transmit power. By adjusting the transmit power in each of the N contiguous slot, the flexibility of the sidelink power control may be improved.

A sum of the transmit powers of the N contiguous slots may be greater than or equal to the first transmit power. In a case where the sum of the transmit powers is equal to the first transmit power, it is understandable that the first terminal device distributes the first transmit power across the N contiguous slots according to certain criteria. By repeatedly transmitting the first sidelink data in the N contiguous slots and distributing the first transmit power across the N contiguous slots, the transmit power requirement of a single slot may be reduced, and the coverage performance may be ensured via the repeated transmissions.

The embodiments of the present disclosure do not limit a relationship between the N contiguous slots and the transmit power. The transmit powers of different slots in the N contiguous slots may be the same, different, partially the same, or partially different. The following describes in detail the relationship between the transmit powers of the different slots in the N contiguous slots in conjunction with embodiment 1 and embodiment 2.

### Embodiment 1

In embodiment 1, the first terminal device configures the transmit power in the different slots in the N contiguous slots, such that the transmit powers of the different slots in the N contiguous slots are equal. Configuring the transmit power to be the same across the N contiguous slots may avoids the need for the terminal device to continuously adjust the transmit power within a short time, thereby decreasing the implementation complexity of the first terminal device.

In some embodiments, the first transmit power may be evenly distributed across the N contiguous slots, such that the transmit power in each of the N contiguous slots is 1/N of the first transmit power. For example, in a case where the first transmit power is the maximum transmit power P_{CMAX}, the first terminal device may evenly distribute P_{CMAX} across the N contiguous slots. In this way, the transmit power in each of the N contiguous slots is P_{CMAX}−10 log N. In the present embodiment, the first transmit power is evenly distributed across the N contiguous slots, and the first sidelink data is repeatedly transmitted on the N contiguous slots. In summary, the total transmit power for the first sidelink data remains unchanged, and no additional transmit power needs to be added, which is beneficial to the power saving of the first terminal device.

In other embodiments, in each of the N contiguous slots, the transmit power in each slot may be adjusted downward by a fixed power offset based on the first transmit power. The fixed power offset may not be associated with the number of slots. The fixed power offset may be determined by at least one of: preconfigured information, configuration information of the network device, or indication information of the second terminal device.

More specifically, referring to FIG. 19, in a case where TB1 is transmitted in one slot, the transmit power in the single slot is P_{CMAX}. Alternatively, in a case where TB1 is transmitted across two contiguous slots (i.e., slot 1-1 and slot 1-2 in FIG. 19), the transmit power in each of the two contiguous slots of slot 1 is P_{CMAX}−10 log 2. That is, the transmit power in slot 1-1 is half of slot 1, and the transmit power in slot 1-2 is also half of slot 1.

Similarly, as illustrated in FIG. 19, in a case where TB2 is transmitted in one slot, the transmit power in the single slot is P_{CMAX}. Alternatively, in a case where TB2 is transmitted across four contiguous slots (i.e., slot 2-1, slot 2-2, slot 2-3, and slot 2-4), the transmit power in the four contiguous slots is P_{CMAX}−10 log 4. That is, the transmit power in slot 2-1 is one fourth of slot 2, the transmit power in slot 2-2 is one fourth of slot 2, the transmit power in slot 2-3 is one fourth of slot 2, and the transmit power in slot 2-4 is one fourth of slot 2.

### Embodiment 2: Not all the Transmit Powers in the N Contiguous Slots are Identical

In embodiment 2, not all transmit powers in the N contiguous slots are identical. For example, the transmit powers of the different slots in the N contiguous slots are different. For another example, the transmit powers in some of the N contiguous slots are the same, the transmit powers in some of the N contiguous slots are different.

In some embodiments the N contiguous slots include X1 slots and X2 slots. X1 and X2 are both positive integers less than N. A sum of X1 and X2 may be less than or equal to N. The transmit power in each of the X1 slots is referred to as a second transmit power, the transmit power in each of the X2 slots is referred to as a third transmit power, wherein the second transmit power is greater than the third transmit power. That is, during the process of transmitting the first sidelink data across N contiguous slots, the first terminal device configures the transmit power in each of the X1 slots as a higher transmit power (the second transmit power) to ensure that the transmit power in the X1 slots satisfies requirements for reception performance. Furthermore, the first terminal device configures the transmit power in the remaining X2 slots as a lower transmit power (the third transmit power) to save power. Although the transmit power in the X2 slots are low, the sidelink data in the X2 slots may still be combined with the sidelink data in the X1 slots to improve the coverage performance of the sidelink transmission.

The above X1 slots may be in any position of the N contiguous slots. In some embodiments, the X1 slots may be contiguous X1 slots within the N contiguous slots. For example, the X1 slots are the initial X1 slots of the N contiguous slots. For another example, the X1 slots are the last X1 slots within the N contiguous slots. For another example, the X1 slots are slots within the N contiguous slots, that is, the X1 slots are X1 slots excluding a first slot and a last slot within the N contiguous slots. Configuring the X1 slots to be contiguous slots avoids the need for the terminal device to frequently adjust the transmit power within a short period of time, thereby simplifying the implementation for the terminal device. Evidently, the X1 slots may also be non-contiguous slots of the N contiguous slots.

More specifically, referring to FIG. 20, in a case where TB3 is transmitted in one slot, P_{CMAX} is the transmit power in the single slot. In a case where TB3 is transmitted across eight contiguous slots, the first terminal device may select the X1 slots from the eight contiguous slots, and each of the X1 slots uses the second transmit power. For example, referring to scenario 1 in FIG. 20, the X1 slots may be the initial three contiguous slots of the eight contiguous slots. For another example, referring to scenario 2 in FIG. 20, the X1 slots may be the last two contiguous slots of the eight contiguous slots. For another example, referring to scenario 3 in FIG. 20, the X1 slots may be selected from the eight contiguous slots according to certain criteria, specifically slot 3-1, slot 3-2, slot 3-5, and slot 3-7.

As mentioned above, the first terminal device transmits the first sidelink data across the X1 slots at the higher second transmit power. The embodiments of the present disclosure do not limit a determination scheme of the second transmit power. In some embodiments, the first terminal device may adjust the transmit power in the X1 slots downwards by a reduced power offset, the reduced power subsequently becomes the second transmit power. The fixed power offset may be determined by at least one of: preconfigured information, configuration information of the network device, or indication information of the second terminal device.

In some embodiments, the second transmit power may be 1/K of the first transmit power (K being a positive integer). A value of K may be fixed or selected from a range of values. For example, K is greater than or equal to X1, and also less than or equal to N. The value of K may be determined by at least one of: preconfigured information, configuration information of the network device, or indication information of the second terminal device. For example, it is assumed that P_{CMAX} is the first transmit power, the second transmit power P2 may satisfy: P2=P_{CMAX}−Q, wherein a value of Q belongs to a set consisting of [10 log X1, 10 log X1+1, 10 log X1+2, . . . , 10 log N]. In a case where Q=10 log X1, the second transmit power is 1/X1 of the first transmit power, i.e., K=X1; in a case where Q=10 log X1+1, the second transmit power is 1/(X1+1) of the first transmit power, i.e., K=X1+1; and so forth.

As described above, the first terminal device transmits the first sidelink data across the X2 slots at the lower third transmit power. The embodiments of the present disclosure do not limit the determination scheme of the third transmit power. In some embodiments, the first terminal device may adjust the transmit power in the X2 slots downward by a fixed power offset based on the first transmit power, the reduced power subsequently becomes the third transmit power. The fixed power offset may be determined by at least one of: preconfigured information, configuration information of the network device, or indication information of the second terminal device.

In other embodiments, the third transmit power may be equal to 1/X2 of a fourth transmit power, and the fourth transmit power may be determined by a difference between the first transmit power and the second transmit power. For example, the fourth transmit power may equal the difference between the first transmit power and the second transmit power. That is, a remaining first transmit power excluding the transmit power used by the X1 slots of the first transmit power may be evenly distributed across the X2 slots. This ensures that the total transmit power in the N contiguous slots is still equal to the first transmit power, without needing to additionally increase the transmit power, which is beneficial to power saving of the first terminal device.

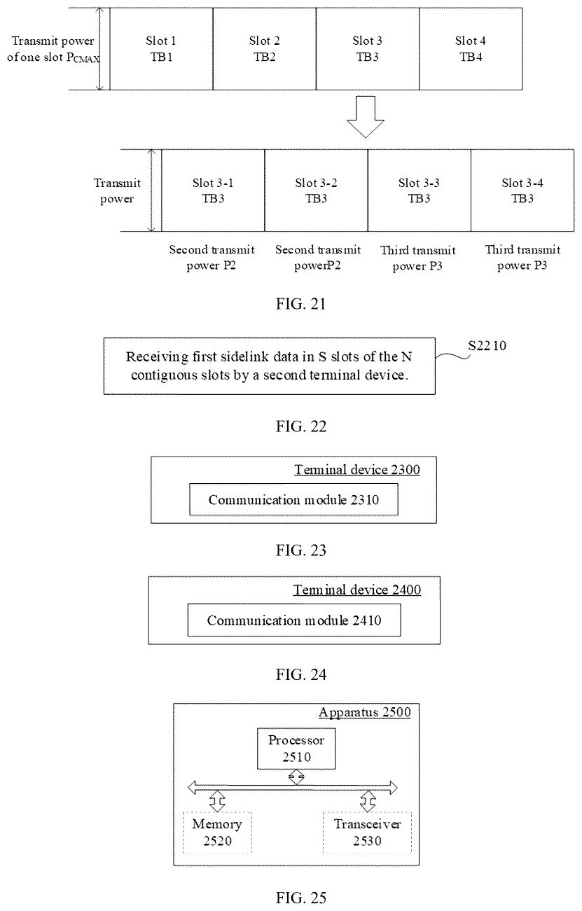

More specifically, referring to FIG. 21, the first terminal device transmits TB3 across four contiguous slots (i.e., slots 3-1, slot 3-2, slot 3-3, and slot 3-4 in FIG. 21). The transmit power of TB3 on slot 3-1 and slot 3-2 is the second transmit power P2, the transmit power of TB3 on slot 3-3 and slot 3-4 is the third transmit power P3, wherein P2>P3. The second transmit power P2=P_{CMAX}-Q, wherein a value range of Q is a set consisting of [10 log X1, 10 log X1+1, 10 log X1+2, . . . , 10 log N]. As illustrated in FIG. 21, X=2, N=4. In a case where Q=10 log X1, the first terminal device transmits TB3 at the second transmit power P2 only across slot 3-1 and slot 3-2, wherein P2 is half of P_{CMAX}. In a case where Q=10 log N, the first terminal device transmits TB3 across slot 3-1, slot 3-2, slot 3-3, and slot 3-4, wherein the transmit power in each of the slots is one fourth of P_{CMAX}, and P2=P3. In a case where Q-[10 log X1+1, 10 log X1+2, . . . , 10 log N−1], P2>P3.

The above describes in detail the sidelink transmission method from the perspective of the transmitter end according to the embodiments of the present disclosure in conjunction with FIG. 18 to FIG. 21. The following describes in detail the sidelink transmission method from the perspective of the receiver end according to the embodiments of the present disclosure in conjunction with FIG. 22. It is understandable that the description regarding the transmitter end corresponds to the description regarding the receiver end. Therefore, for details not disclosed in the following embodiment, reference may be made to the embodiment of the transmitter end.

FIG. 22 is a schematic flowchart of the sidelink transmission method according to some embodiments of the present disclosure. FIG. 22 is described from the perspective of the second terminal device, wherein the second terminal device is a device for receiving the first sidelink data. The second terminal device may be any type of terminal device supporting sidelink communication. In some embodiments, the second terminal device may be a reduced capability terminal device. For example, the second terminal device may be a terminal device with a relatively high power saving requirement. Additionally, the sidelink transmission method illustrated in FIG. 22 may be applicable to a licensed spectrum or an unlicensed spectrum.

Referring to FIG. 22, in S2210, the second terminal device receives the first sidelink data in S slots of the N contiguous slots. The N contiguous slots are used to repeatedly transmit the first sidelink data, wherein Nis a positive integer greater than 1, and S is a positive integer less than or equal to N. In a case where S is equal to N, the second terminal device receives the first sidelink data in all the N contiguous slots, such that the reception reliability of the first sidelink data is maximized. In a case where S is less than N, the second terminal device may select part of the N slots to receive the first sidelink data, thereby reducing combination complexity.

In some embodiments, the S slots are contiguous slots. Receiving the first sidelink data across contiguous slots may avoid the need for the second terminal device to frequently switch between a receiving state and a non-receiving state within a short period of time, thereby simplifying the reception operation of the second terminal device. Alternatively, in some other embodiments, the S slots may be non-contiguous slots.

In some embodiments, upon receiving the first sidelink data in the S slots, the first terminal device may combine the first sidelink data from the S slots to acquire a reception combining gain.

In some other embodiments, upon receiving the first sidelink data in the S slots, the second terminal device may combine the first sidelink data transmitted by L slots within the S slots (L slots may be contiguous or non-contiguous slots within the S slots), wherein L is a positive integer less than S. The second terminal device selects part of the S slots to combine the first sidelink data, which may reduce combination complexity.

It should be noted that the description of the transmit power in the N contiguous slots in the transmitter embodiments may also be applicable to the receiver embodiments. For example, from the perspective of the receiver end, a receive power in each of the N contiguous slots is also less than the first transmit power, and the receive powers of different slots of the N slots may be the same or different, of which the descriptions are not repeated herein for brevity.

The method embodiments of the present disclosure are described in detail above in conjunction with FIG. 1 to FIG. 22. The following describes in detail the apparatus embodiments of the present disclosure in conjunction with FIG. 23 to FIG. 25. It should be understood that the description of the method embodiments corresponds to the description of the apparatus embodiments correspond. Therefore, for details not described in the apparatus embodiments, reference may be made to the method embodiments.

FIG. 23 is a schematic structural diagram of a terminal device 2300 according to some embodiments of the present disclosure. The terminal device 2300 illustrated in FIG. 23 may be the first terminal device mentioned in any of the above embodiments. The terminal device 2300 includes a communication module 2310. The communication module 2310 is configured to repeatedly transmit first sidelink data in N contiguous slots, wherein a transmit power in each of the N contiguous slots is less than a first transmit power, the first transmit power being less than or equal to a maximum transmit power allowed by the first terminal device, and N being a positive integer greater than 1.

In some embodiments, the transmit powers in different slots of the N slots are equal.

In some embodiments, the transmit power in each of the N contiguous slots is 1/N of the first transmit power.

In some embodiments, not all the transmit power in the N contiguous slots are identical.

In some embodiments, the N slots include X1 slots and X2 slots, the transmit power in each of the X1 slots is a second transmit power, and the transmit power in each of the X2 slots is a third transmit power, wherein the second transmit power is greater than the third transmit power, and both X1 and X2 are positive integers less than N.

In some embodiments, the X1 slots are contiguous slots.

In some embodiments, the X1 slots satisfy one of the following conditions: the X1 slots are the initial X1 slots of the N contiguous slots; the X1 slots are the last X1 slots of the N contiguous slots; or the X1 slots are X1 slots excluding a first slot and a last slot of the N contiguous slots.

In some embodiments, the X1 slots are non-contiguous slots.

In some embodiments, the second transmit power is 1/K of the first transmit power, K being a positive integer.

In some embodiments, K is greater than or is equal to X1, and K is less than or equal to N.

In some embodiments, a third transmit power is equal to 1/X2 of a fourth transmit power, wherein the fourth transmit power is determined based on a difference between the first transmit power and the second transmit power.

In some embodiments, a sum of the transmit powers of the N contiguous slots is equal to the first transmit power.

In some embodiments, the transmit power in each of the N contiguous slots is determined based on the number of the N slots.

In some embodiments, the transmit power is determined based on at least one of: a maximum transmit power allowed for the first terminal device; a transmit power of a PSSCH determined by a downlink pathloss; a transmit power of a PSSCH determined by a sidelink pathloss; or a maximum sidelink transmit power determined by at least one of a transmit priority or a channel occupancy rate.

In some embodiments, the first sidelink data is transmitted over a frequency resource in an unlicensed spectrum.

In some embodiments, the first sidelink data is a TB.

FIG. 24 is another schematic structural diagram of a terminal device 2400 according to some embodiments of the present disclosure. The terminal device 2400 illustrated in FIG. 24 may be the second terminal device mentioned in any of the above embodiments. The terminal device 2400 includes a communication module 2410. The communication module 2410 is configured to receive first sidelink data in S slots of N contiguous slots, wherein the N contiguous slots are used to repeatedly transmit the first sidelink data, N being a positive integer greater than 1, and S being a positive integer less than or equal to N.

In some embodiments, the S slots are contiguous or non-contiguous slots.

In some embodiments, the terminal device 2400 further includes: a first combining module configured to combine the first sidelink data transmitted in the S slots.

In some embodiments, the terminal device 2400 further include: a second combining module configured to combine the first sidelink data transmitted in L slots of the S slots, wherein Lis a positive integer less than S.

In some embodiments, the L slots are contiguous or non-contiguous slots.

In some embodiments, the first sidelink data is transmitted using a licensed spectrum or an unlicensed spectrum.

In some embodiments, the sidelink data is a TB.

FIG. 25 is a schematic structural diagram of an apparatus 2500 according to some embodiments of the present disclosure. The dotted lines in FIG. 25 indicate that the element or module is optional. The apparatus 2500 may be configured to implement the method embodiments of the present disclosure. The apparatus 2500 may be a chip or a terminal device.

The apparatus 2500 may include one or more processors 2510. The processor 2510 may implement the method embodiments of the present disclosure. The processor 2510 may be a general purpose processor or a dedicated processor. For example, the processor may be a central processing unit (CPU). Alternatively, the processor may further be another general purpose processor, a digital signal processor (DSP), an application-specific integrated circuit (ASIC), a field-programmable gate array (FPGA) or another programmable logic device, a discrete gate or transistor logic device, a discrete hardware component, or the like. A general purpose processor may be a microprocessor, or the processor may be any conventional processor or the like.

The apparatus 2500 may include one or more memories 2520. The memory 2520 stores one or more computer programs, wherein a processor is configured to run the one or more computer programs to cause the apparatus to perform the above method embodiments. The memory 2520 may be independent of the processor 2510 or integrated into the processor 2510.

The apparatus 2500 may also include a transceiver 2530. The processor 2510 may perform communication with another device or a chip via the transceiver 2530. For example, the processor 2510 may perform data transmission and reception with another device or the chip via the transceiver 2530.

Some embodiments of the present disclosure further provide a computer-readable storage medium storing one or more computer programs. The computer-readable storage medium is applicable to the terminal device according to the embodiments of the present disclosure, and the one or more programs, when run on a computer, cause the computer to perform the method performed by the terminal device according to the embodiments of the present disclosure.

Some embodiments of the present disclosure further provide a computer program product. The computer program product includes one or more computer programs. The computer program product is applicable to the terminal device according to the embodiments of the present disclosure, and the one or more programs, when run on a computer, cause the computer to perform the method performed by the terminal device according to the embodiments of the present disclosure.

Some embodiments of the present disclosure further provide a computer program applicable to the terminal device according to the embodiments of the present disclosure, and the computer program, when run on a computer, causes the computer to perform the method performed by the terminal device according to the embodiments of the present disclosure.

It should be understood that the terms “system” and “network” may be used interchangeably. Addition, the terminology used in the present disclosure merely describes the specific embodiments of the present disclosure, and is not intended to limit the present disclosure. The term “first,” “second,” “third,” “fourth,” and the like in the specification, the claims, and the accompanying drawings of the present disclosure are merely used to distinguish different objects, and are not used to describe a specific order. Furthermore, the term “include,” “have,” and any variants thereof are intended to cover non-exclusive inclusion.

It should be understood that the term “indication” mentioned in the embodiments of the present disclosure refers to a direct indication, an indirect indication, or an indication that there is an association relationship. For example, A indicates B, which may mean that A indicates B directly, e.g., B may be acquired by A, or that A indicates B indirectly, e.g., A indicates C by which B may be acquired, or that an association relationship is present between A and B.

In the embodiments of the present disclosure, the expression “B corresponding to A” indicates that B is associated with A, and B may be determined based on A. However, it should be understood that determining B based on A does not imply that B is determined solely based on A; rather, B may also be determined on A and/or other information.

In the description of the embodiments of the present disclosure, the term “correspond” indicates a direct or indirect corresponding relationship between two items, or indicates an associated relationship between two items; and also indicates relationships such as indicating and being indicated, or configuring and being configured.

In some embodiments of the present disclosure, the term “predefined” is implemented by pre-storing corresponding codes, tables, or other means that may be defined to indicate related message in devices (including, for example, terminal devices and network devices), and the present disclosure does not limit the specific implementation thereof. For example, the term “predefined” refers to being “defined” in a protocol.

In some embodiments of the present disclosure, the term “protocol” refers to a standard or a protocol in the communication field including, for example, the LTE protocol, the NR protocol, and related protocols applied in the future communication systems, which is not limited in the present disclosure.

The term “and/or” describes the association relationship between the associated objects, and indicates that three relationships may be present. For example, the phrase “A and/or B” means (A), (B), or (A and B). The symbol “/” generally indicates an “or” relationship between the associated objects.

In addition, serial numbers of the processes described herein only show an exemplary possible sequence of performing the processes. In some other embodiments, the processes may also be performed out of the numbering sequence, for example, two processes with different serial numbers are performed simultaneously, or two processes with different serial numbers are performed in reverse order to the illustrated sequence, which is not limited in the present disclosure.

In the several embodiments provided by the present disclosure, it should be understood that the disclosed system, apparatus, and method may be implemented in other manners. For example, the apparatus embodiments described above are merely illustrative. For example, the division of the units is merely a logical function division, and there may be other division schemes in practice. For example, the multiple units or components may be combined or integrated into another system, or some features may be ignored or not performed. Additionally, the displayed or discussed mutual coupling, direct coupling, or communication connection may be an indirect coupling or a communication connection over some interface, apparatus, or unit, and may be in an electrical, a mechanical, or other form.

The units described as separate components may or may not be physically separate. The components displayed as units may or may not be physical units; that is, they may be located in one place, or may be distributed across multiple network units. Some or all of the units may be selected according to the actual requirements to achieve the objectives of the technical solutions of the embodiments of the present disclosure.

Additionally, each functional unit in the several embodiments of the present disclosure may be integrated into one processing unit, or each unit may physically exist independently, or two or more units may be integrated into one unit.

In the above embodiments, the functions described in the embodiments of the present disclosure may be implemented in software, hardware, firmware or any combination thereof. he functions, when implemented in software, may be stored in a computer-readable medium or transmitted as one or more instructions or codes on a computer-readable medium. The computer program product includes one or more computer instructions. When the computer program instructions are loaded and executed on a computer, the procedures or functions according to the embodiments of the present application are generated in whole or in part. The computer may be a general-purpose computer, a special-purpose computer, a computer network, or another programmable apparatus. One or more computer instructions may be stored in a computer-readable storage medium or may be transmitted from one computer-readable storage medium to another. For example, the computer instructions may be transmitted from a website, a computer, a server, or a data center to another website, computer, server, or data center in a wired manner (e.g., a coaxial cable, an optical fiber, or a digital subscriber line (DSL)) or a wireless manner (e.g., infrared, radio, or microwave). The computer-readable storage medium may be any available medium that may be read by the computer, or the data storage device, such as the server or the data center, integrating one or more available media. The medium may be a magnetic medium (for example, a floppy disk, a hard disk, or a magnetic tape), an optical medium (e.g., a digital video disc (DVD)), or a semiconductor medium (e.g., a solid-state disk (SSD)).

Described above are merely exemplary embodiments of the present disclosure and are not intended to limit the present disclosure. Any modifications, equivalent substitutions, improvements and the like, made within the spirit and principle of the present disclosure should fall within the protection scope of the present disclosure.

1. A sidelink transmission method, performed by a first terminal device, the method comprising:
repeatedly transmitting first sidelink data in N contiguous slots, wherein a transmit power in each of the N contiguous slots is less than a first transmit power, the first transmit power being less than or equal to a maximum transmit power allowed for the first terminal device, and N being a positive integer greater than 1.

2. The method according to claim 1, wherein the transmit powers in different slots in the N contiguous slots are equal.

3. The method according to claim 2, wherein the transmit power in each slot of the N contiguous slots is 1/N of the first transmit power.

4. The method according to claim 1, wherein not all the transmit powers in the N slots are identical.

5. The method according to claim 4, wherein the N slots comprise X1 slots and X2 slots, the transmit power in each of the X1 slots is a second transmit power, and the transmit power in each of the X2 slots is a third transmit power, wherein the second transmit power is greater than the third transmit power, and both X1 and X2 are positive integers less than N.

6. The method according to claim 5, wherein the X1 slots are contiguous slots.

7. The method according to claim 6, wherein the X1 slots satisfy one of the following conditions:
the X1 slots are the initial X1 slots in the N slots;
the X1 slots are the last X1 slots in the N slots; or
the X1 slots are X1 slots excluding a first slot and a last slot in the N slots.

8. The method according to claim 5, wherein the X1 slots are non-contiguous slots.

9. The method according to claim 5, wherein a second transmit power is 1/K the first transmit power, K being a positive integer.

10. The method according to claim 9, wherein K is greater than or equal to X1, and K is less than or equal to N.

11. The method according to claim 5, wherein a third transmit power is equal to 1/X2 of a fourth transmit power, wherein the fourth transmit power is determined based on a difference between the first transmit power and the second transmit power.

12. The method according to claim 1, wherein a sum of the transmit powers of the N contiguous slots is equal to the first transmit power.

13. The method according to claim 1, wherein the transmit power in each of the N slots is determined based on a number of the N slots.

14. The method according to claim 1, wherein the first transmit power is determined based on at least one of:
a maximum transmit power allowed for the first terminal device;
a transmit power of a physical sidelink shared channel (PSSCH) determined by a downlink pathloss;
a transmit power of a PSSCH determined by a sidelink pathloss; or
a maximum sidelink transmit power determined by at least one of a transmit priority or an occupancy rate.

15. A sidelink transmission method, performed by a second terminal device, the method comprising:
receiving first sidelink data in S slots of N contiguous slots, the N contiguous slots being used to repeatedly transmit first sidelink data, wherein N is a positive integer greater than 1, and S is a positive integer less than or equal to N.

16. The method according to claim 15, wherein the S slots are contiguous slots or the S slots are non-contiguous slots.

17. The method according to claim 15, further comprising:
combining the first sidelink data from the S slots.

18. The method according to claim 15, further comprising:
combining the first sidelink data from L slots of the S slots, L being a positive integer less than S.

19. The method according to claim 18, wherein the L slots are contiguous slots or the L slots are non-contiguous slots.

20. A terminal device, comprising:
a transceiver;
a memory storing one or more computer programs; and
a processor configured to execute the one or more programs to cause the terminal device to:
repeatedly transmit first sidelink data in N contiguous slots, wherein a transmit power in each of the N contiguous slots is less than a first transmit power, the first transmit power being less than or equal to a maximum transmit power allowed for the first terminal device, and N being a positive integer greater than 1.
